(19) United States
(12) Patent Application Publication
(10) Pub. No.: US 2025/0219058 A1
(43) Pub. Date: Jul. 3, 2025

(54) Positive Electrode Active Material and Lithium-ion Battery

(71) Applicant: EVE POWER CO., LTD., Jingmen (CN)

(72) Inventors: Gang Liu, Jingmen (CN); Shihao Liu, Jingmen (CN); Zhongyang Shi, Jingmen (CN); Fanfen Liu, Jingmen (CN); Dingding Yuan, Jingmen (CN)

(21) Appl. No.: 18/761,444

(22) Filed: Jul. 2, 2024

(30) Foreign Application Priority Data
Dec. 29, 2023 (CN) 202311869845.X

(51) Int. Cl. H01M 4/36; C01B 25/45; H01M 4/02; H01M 4/58; H01M 4/587; H01M 10/0525

(52) U.S. Cl. CPC H01M 4/366; C01B 25/45; H01M 4/5825; H01M 4/587; H01M 10/0525; C01P 2002/82; C01P 2004/86; C01P 2006/40; H01M 2004/028

(57) ABSTRACT

Disclosed in the present disclosure is a positive electrode active material and a lithium-ion battery, the positive electrode active material comprising lithium iron phosphate coated with carbon layer, and an I_{D}/I_{G} value of the positive electrode active material is 0.75-1.2, wherein a peak intensity at a wave number of 1360 cm⁻¹ is considered as I_{D} and a peak intensity at a wave number of 1580 cm⁻¹ is considered as I_{G} in a Raman spectrum of the positive electrode active material.

### CROSS-REFERENCE TO RELATED APPLICATION

The present application claims priority of Chinese Patent Application No. 202311869845.X filed on Dec. 29, 2023 before CNIPA. All the above are hereby incorporated by reference in their entirety.

### FIELD

The present disclosure relates to the technical field of batteries and, particularly, to a positive electrode active material and a lithium-ion battery.

### BACKGROUND

Lithium iron phosphate is widely used as positive electrode material for lithium-ion batteries due to its wide range of raw material sources, high theoretical specific capacity, stable voltage platform, good safety performance and low cost. However, the electronic conductivity of LiFePO₄ is relatively small at about 10⁻⁹ S/cm. Moreover, its olivine structure has only one-dimensional Li⁺ diffusion channels, and the diffusion of Li⁺ is hindered when the material structure is changed or the LiFePO₄ surface is blocked by impurities, resulting in low Li⁺ diffusion coefficients (about 10⁻¹⁴-10⁻¹⁶ cm²/s at room temperature), which is especially serious at low temperatures.

In order to improve the electrical conductivity and low-temperature performance of LiFePO₄, the commonly used methods are: (1) doping high-valent ions or metal oxides to increase the intrinsic conductivity of the material; (2) reducing the particle size to shorten the diffusion distance of Li⁺; and (3) employing carbon coating or coating other conductive substances on the surface of the LiFePO₄ material to increase the surface electrical conductivity of the material. However, the increased diffusion rate of Li⁺ does not significantly improve the low-temperature performance of LiFePO₄. As Li⁺ transfer at the interface is a rate-determining step in the LiFePO₄ electrode reaction compared to diffusion within the stereoscopic phase, the relatively poor low-temperature performance originates from the slow Li⁺ transfer process at the interface between the electrode and the electrolyte.

Therefore, there is an urgent need in the art for a technical scheme that promotes the transfer of Li⁺ at the interface between the electrode and the electrolyte, improves the electrical conductivity of LiFePO₄, thereby increasing the rate performance, and improves the low-temperature performance of lithium iron phosphate positive electrode materials.

### SUMMARY

The present disclosure aims to solve the following technical problems: how to improve the Li⁺ transfer rate at the interface between the electrode and the electrolyte, and improve the electrical conductivity of lithium iron phosphate, thereby improving the rate performance, which improves the low-temperature performance of lithium iron phosphate.

As a first aspect, provided in the present disclosure is a positive electrode active material, including lithium iron phosphate coated with carbon layer, and an I_{D}/I_{G} value of the positive electrode active material is 0.75-1.2, wherein a peak intensity at a wave number of 1360 cm⁻¹ is considered as I_{D} and a peak intensity at a wave number of 1580 cm⁻¹ is considered as I_{G} in a Raman spectrum of the positive electrode active material.

As a second aspect, provided in the present disclosure is a lithium-ion battery including the positive electrode active material.

In the present disclosure, the lithium-ion battery includes a positive electrode active material including the lithium iron phosphate coated with carbon layer with the I_{D}/I_{G} value being 0.75-1.2, which increases the desolvation (removal of solventized shell) rate of Li⁺ at the interface of the electrode and the electrolyte and enhances the desolvation ability, thereby increasing the electrical conductivity of lithium iron phosphate and improving the rate performance and the low-temperature performance of lithium-ion batteries including the positive electrode active material.

### DETAILED DESCRIPTION OF THE EXAMPLES

In the present disclosure, I_{D}/I_{G} value of the positive electrode active material is 0.75-1.2, which may be, but is not limited to the values listed below, such as 0.75, 0.78, 0.8, 0.82, 0.85, 0.88, 0.9, 0.92, 0.95, 0.98, 1.0, 1.02, 1.05, 1.08, 1.1, 1.12, 1.15, 1.18, and 1.2, and other values in the range but not listed are also applicable.

I_{D}/I_{G} value of the lithium iron phosphate coated with carbon layer of the positive electrode active material in the present disclosure is 0.75-1.2, which increases the desolvation rate of Li⁺ at the interface between the electrode and electrolyte and enhances the desolvation ability, thereby increasing the conductivity and rate performance of lithium iron phosphate, and improving the low-temperature performance of lithium iron phosphate.

In one implementation, I_{D}/I_{G} value of the positive electrode active material is 0.8-1.0, which may be, but is not limited to the values listed below, such as 0.8, 0.82, 0.85, 0.88, 0.9, 0.92, 0.95, 0.98, and 1.0, and other values in the range but not listed are also applicable.

In the present scheme, the I_{D}/I_{G} value of the positive electrode active material is 0.8-1.0. The I_{D}/I_{G} value is in such a range to further increase the desolvation rate of Li⁺ at the interface between the electrode and electrolyte and enhance the desolvation ability, thereby increasing the conductivity and rate performance of lithium iron phosphate, and improving the low-temperature performance of lithium iron phosphate.

In one implementation, a thickness of the carbon layer is 2-6 nm, which may be, but is not limited to the values listed below, such as 2 nm, 3 nm, 4 nm, 5 nm, and 6 nm, and other values in the range but not listed are also applicable.

In the present scheme, the thickness of the carbon layer is 2-6 nm, which may cover lithium iron phosphate well, reduce the polarization phenomenon in the migration process, and play a certain shielding role, thereby improving the stability of the battery, while short lithium-ion transport channel is conducive to further improve the rate performance of lithium-ion batteries.

In one implementation, D₅₀ of the positive electrode active material is 0.8-1.6 m, which may be, but is not limited to the values listed below, such as, 0.8 m, 0.9 m, 1.0 m, 1.1 m, 1.2 m, 1.3 m, 1.4 m, 1.5 m, and 1.6 m, and other values in the range but not listed are also applicable.

In the present scheme, the D₅₀ of the positive electrode active material is 0.8-1.6 m. The lithium-ion transport channel is short when the D₅₀ is in such a range, which shortens the diffusion distance of Li⁺ and improves the rate performance of lithium-ion batteries, and also ensures a sufficiently sized particle diameter so that the positive electrode active material is less likely to form soft agglomerates and avoids blocking during processing.

In one implementation, a method of preparing the positive electrode active material includes following steps: ball-milling a mixture of a FePO₄ precursor, a lithium source, a carbon source and a dispersant, and sintering to prepare the positive electrode active material.

In one implementation, the FePO₄ precursor includes at least one of FePO₄ and FePO₄ coated with a carbon source.

In one implementation, the carbon source includes at least one of glucose and polyethylene glycol.

In the present scheme, the carbon source includes at least one of glucose and polyethylene glycol. After melting, glucose may form a liquid with a certain viscosity, which is easy to be coated on the surface of lithium iron phosphate, and a porous carbon layer is formed after carbonization, which is conducive to the infiltration of the electrolyte and the migration of lithium-ions, and improves the rate performance of lithium-ion batteries. The pyrolysis of polyethylene glycol produces highly graphitized carbon, which is conducive to regulating the I_{D}/I_{G} value in the range of 0.75-1.2. The synergistic effect of glucose and polyethylene glycol mentioned above is conducive to further increasing the electrical conductivity as well as rate performance of lithium iron phosphate, and to improving the low-temperature performance of lithium iron phosphate.

In one implementation, the carbon source includes the glucose and the polyethylene glycol, in which a mass ratio of the glucose to the polyethylene glycol is (0.6-1.2):1, which may be, but is not limited to the values listed below, such as, 0.6:1, 0.7:1, 0.8:1, 0.9:1, 1:1, 1.1:1, and 1.2:1, and other values in the range but not listed are also applicable.

In the present scheme, the carbon source includes the glucose and the polyethylene glycol, in which a mass ratio of the glucose to the polyethylene glycol is (0.6-1.2):1. It ensures that the carbon coating layer of the positive electrode active material is of sufficiently porous structure, which is conducive to the infiltration of the electrolyte and the migration of lithium-ions, and improves the rate performance of lithium-ion batteries; and it is also conducive to regulating the I_{D}/I_{G} to an I_{D}/I_{G} value in the range of 0.75-1.2, which is conducive to further increasing the electrical conductivity of lithium iron phosphate as well as its rate performance, and improving the low-temperature performance of lithium iron phosphate.

In one implementation, temperature of the sintering is 680-720° C.

### Example 1

### 1. Preparation of Lithium Iron Phosphate Coated with Carbon Layer

In step 1, the preparation of precursor FePO₄:0.965 mol ferrous sulfate heptahydrate (FeSO₄·7H₂O) was dissolved in 100 mL of deionized water; 100 mL of phosphoric acid solution at a concentration of 10 mol/L, 100 mL of hydrogen peroxide at a concentration of 30% (mass fraction) and 7.5 mL furfuryl alcohol monomer were added; and the reaction was carried out for 3 h at 70° C. After the reaction was finished, the pH was adjusted to 1.5 by adding 0.1 mol/L NaOH solution; after stirring at room temperature for 2 h, the FePO₄·2H₂O coated with polyfurfuryl alcohol was obtained by filtration, rinsing, and grinding after drying for 5 h at 90° C.

In step 2, the preparation of the lithium iron phosphate coated with carbon layer: the FePO₄·2H₂O coated with polyfurfuryl alcohol was dehydrated at 600° C. for 6 h in a box-type resistance furnace to obtain the FePO₄ coated with polyfurfuryl alcohol; the obtained dehydrated FePO₄ coated with polyfurfuryl alcohol, 0.308 mol of lithium acetate, 0.708 mol of lithium hydroxide, 7 g of glucose, and 7 g of polyethylene glycol (PEG) were fed into a ball mill; 200 mL of anhydrous ethanol was added as the dispersant; the precursor slurry was obtained by grinding with 2 mm zirconium balls for 2 h; the precursor slurry was placed in a microwave oven for drying; the slurry was then transferred to a tube-type resistance furnace protected by an N₂ atmosphere; and sintering was carried out at 695° C. for 6.5 h, to prepare the lithium iron phosphate coated with carbon layer.

### 2. Preparation of Lithium-Ion Batteries

### (1) Preparation of Positive Electrode Sheet

The lithium iron phosphate coated with the carbon layer prepared in the present example was used as the positive electrode active material. Positive electrode active material of lithium iron phosphate coated with carbon layer, binder PVDF (polyvinylidene fluoride), dispersant PVP (polyvinylpyrrolidone), and conductive agent SP (conductive carbon black Super-P) were mixed and stirred homogeneously to obtain the positive electrode slurry according to a mass ratio of 97.4%:1.6%:0.2%:0.8%. Then, the positive electrode slurry was applied on the aluminum foil by coating process, and the positive electrode sheet was obtained after drying and cold pressing process.

### (2) Preparation of Negative Electrode Sheet

The negative electrode active material of graphite, binder SBR (styrene butadiene rubber), dispersant CMC (Carboxymethyl Cellulose), and conductive agent SP (conductive carbon black Super-P) were mixed and stirred homogeneously to obtain the negative electrode slurry according to a mass ratio of 96.7%:1.5%:1.2%:0.6%. Then, the negative electrode slurry was applied on the copper foil by coating process, and the negative electrode sheet was obtained after drying and cold pressing process.

### (3) Selection of Electrolyte

Vinyl carbonate electrolyte was selected for the preparation of lithium-ion batteries.

### (4) Selection of Separator

Polyethylene (PE) film is used as the separator.

### (5) Preparation of Lithium-Ion Batteries

The aforementioned positive electrode sheet, separator, and negative electrode sheet were sequentially stacked, so that the separator was between the positive electrode sheet and the negative electrode sheet to play the role of separation, and were then wound to obtain a bare cell;

### 3. Raman Spectroscopy

In step 1, Sample making: The positive electrode active material of lithium iron phosphate coated with a carbon layer was laid flat in a sample tank to make a sample, and attention should be paid to keeping the upper surfaces of the samples made therefrom on the same horizontal plane.

In step 2, Testing: The equipment model i-Raman® Prime instrument connected to the computer and BWSpec software was used for conducting Raman testing, the distance between the laser and the test sample was adjusted to collect the Raman spectrum, the peak intensity was adjusted to the maximum Raman peak intensity for the focusing of the optimal test position, the data was saved, and the Raman curve was analyzed with the BWSpec software by deducting the background baseline. Data processing: The peak intensity at a wave number of about 1360 cm⁻¹ was read as I_{D}, and the peak intensity at a wave number of about 1580 cm⁻¹ was read as I_{G}, and the value of I_{D}/I_{G} was calculated.

### Example 2

### 1. Preparation of Lithium Iron Phosphate Coated with Carbon Layer

In step 1, the preparation of precursor FePO₄:0.965 mol ferrous sulfate heptahydrate (FeSO₄·7H₂O) was dissolved in 100 mL of deionized water; 100 mL of phosphoric acid solution at a concentration of 10 mol/L, 100 mL of hydrogen peroxide at a concentration of 30% (mass fraction) and 7.5 mL furfuryl alcohol monomer were added; and the reaction was carried out for 3 h at 70° C. After the reaction was finished, the pH was adjusted to 1.5 by adding 0.1 mol/L NaOH solution; after stirring at room temperature for 2 h, the FePO₄·2H₂O coated with polyfurfuryl alcohol was obtained by filtration, rinsing, and grinding after drying for 5 h at 90° C.

In step 2, the preparation of the lithium iron phosphate coated with carbon layer: the FePO₄·2H₂O coated with polyfurfuryl alcohol was dehydrated at 600° C. for 6 h in a box-type resistance furnace to obtain the FePO₄ coated with polyfurfuryl alcohol; the obtained dehydrated FePO₄ coated with polyfurfuryl alcohol, 0.308 mol of lithium acetate, 0.708 mol of lithium hydroxide, 7 g of glucose, and 7 g of polyethylene glycol (PEG) were fed into a ball mill; 200 mL of anhydrous ethanol was added as the dispersant; the precursor slurry was obtained by grinding with 2 mm zirconium balls for 2 h; the precursor slurry was placed in a microwave oven for drying; the slurry was then transferred to a tube-type resistance furnace protected by an N₂ atmosphere; and sintering was carried out at 695° C. for 8 h, to prepare the lithium iron phosphate coated with carbon layer.

### 2. Preparation of Lithium-Ion Batteries

Adopting the lithium iron phosphate coated with carbon layer prepared in the present example as the positive electrode active material, the preparation of the lithium-ion battery of the present example is carried out with reference to the scheme for preparing the lithium-ion battery adopted in Example 1, and except for the lithium iron phosphate coated with carbon layer adopted as the positive electrode active material, the other materials used for preparing the lithium-ion battery as well as the proportion and the operation in the present example are all strictly consistent with those corresponding to the descriptions in Example 1.

### 3. Raman Spectroscopy

Raman Spectroscopy using the lithium iron phosphate positive electrode active material coated with carbon layer prepared in the present example was strictly consistent with the corresponding descriptions in Example 1.

### Example 3

### 1. Preparation of Lithium Iron Phosphate Coated with Carbon Layer

In step 1, the preparation of precursor FePO₄: 0.965 mol ferrous sulfate heptahydrate (FeSO₄·7H₂O) was dissolved in 100 mL of deionized water; 100 mL of phosphoric acid solution at a concentration of 10 mol/L, 100 mL of hydrogen peroxide at a concentration of 30% (mass fraction) and 7.5 mL furfuryl alcohol monomer were added; and the reaction was carried out for 3 h at 70° C. After the reaction was finished, the pH was adjusted to 1.5 by adding 0.1 mol/L NaOH solution; after stirring at room temperature for 2 h, the FePO₄·2H₂O coated with polyfurfuryl alcohol was obtained by filtration, rinsing, and grinding after drying for 5 h at 90° C.

In step 2, the preparation of the lithium iron phosphate coated with carbon layer: the FePO₄·2H₂O coated with polyfurfuryl alcohol was dehydrated at 600° C. for 6 h in a box-type resistance furnace to obtain the FePO₄ coated with polyfurfuryl alcohol; the obtained dehydrated FePO₄ coated with polyfurfuryl alcohol, 0.308 mol of lithium acetate, 0.708 mol of lithium hydroxide, 7 g of glucose, and 7 g of polyethylene glycol (PEG) were fed into a ball mill; 200 mL of anhydrous ethanol was added as the dispersant; the precursor slurry was obtained by grinding with 2 mm zirconium balls for 2 h; the precursor slurry was placed in a microwave oven for drying; the slurry was then transferred to a tube-type resistance furnace protected by an N₂ atmosphere; and sintering was carried out at 695° C. for 6 h, to prepare the lithium iron phosphate coated with carbon layer.

### 2. Preparation of Lithium-Ion Batteries

Adopting the lithium iron phosphate coated with carbon layer prepared in the present example as the positive electrode active material, the preparation of the lithium-ion battery of the present example is carried out with reference to the scheme for preparing the lithium-ion battery adopted in Example 1, and except for the lithium iron phosphate coated with carbon layer adopted as the positive electrode active material, the other materials used for preparing the lithium-ion battery as well as the proportion and the operation in the present example are all strictly consistent with those corresponding to the descriptions in Example 1.

### 3. Raman Spectroscopy

Raman Spectroscopy using the lithium iron phosphate positive electrode active material coated with carbon layer prepared in the present example was strictly consistent with the corresponding descriptions in Example 1.

### Example 4

### 1. Preparation of Lithium Iron Phosphate Coated with Carbon Layer

In step 1, the preparation of precursor FePO₄: 0.965 mol ferrous sulfate heptahydrate (FeSO₄·7H₂O) was dissolved in 100 mL of deionized water; 100 mL of phosphoric acid solution at a concentration of 10 mol/L, 100 mL of hydrogen peroxide at a concentration of 30% (mass fraction) and 7.5 mL furfuryl alcohol monomer were added; and the reaction was carried out for 3 h at 70° C. After the reaction was finished, the pH was adjusted to 1.5 by adding 0.1 mol/L NaOH solution; after stirring at room temperature for 2 h, the FePO₄·2H₂O coated with polyfurfuryl alcohol was obtained by filtration, rinsing, and grinding after drying for 5 h at 90° C.

In step 2, the preparation of the lithium iron phosphate coated with carbon layer: the FePO₄·2H₂O coated with polyfurfuryl alcohol was dehydrated at 600° C. for 6 h in a box-type resistance furnace to obtain the FePO₄ coated with polyfurfuryl alcohol; the obtained dehydrated FePO₄ coated with polyfurfuryl alcohol, 0.308 mol of lithium acetate, 0.708 mol of lithium hydroxide, 7 g of glucose, and 7 g of polyethylene glycol (PEG) were fed into a ball mill; 200 mL of anhydrous ethanol was added as the dispersant; the precursor slurry was obtained by grinding with 2 mm zirconium balls for 1.5 h; the precursor slurry was placed in a microwave oven for drying; the slurry was then transferred to a tube-type resistance furnace protected by an N₂ atmosphere; and sintering was carried out at 695° C. for 6.5 h, to prepare the lithium iron phosphate coated with carbon layer.

### 2. Preparation of Lithium-Ion Batteries

Adopting the lithium iron phosphate coated with carbon layer prepared in the present example as the positive electrode active material, the preparation of the lithium-ion battery of the present example is carried out with reference to the scheme for preparing the lithium-ion battery adopted in Example 1, and except for the lithium iron phosphate coated with carbon layer adopted as the positive electrode active material, the other materials used for preparing the lithium-ion battery as well as the proportion and the operation in the present example are all strictly consistent with those corresponding to the descriptions in Example 1.

### 3. Raman Spectroscopy

Raman Spectroscopy using the lithium iron phosphate positive electrode active material coated with carbon layer prepared in the present example was strictly consistent with the corresponding descriptions in Example 1.

### Example 5

### 1. Preparation of Lithium Iron Phosphate Coated with Carbon Layer

In step 1, the preparation of precursor FePO₄: 0.965 mol ferrous sulfate heptahydrate (FeSO₄·7H₂O) was dissolved in 100 mL of deionized water; 100 mL of phosphoric acid solution at a concentration of 10 mol/L, 100 mL of hydrogen peroxide at a concentration of 30% (mass fraction) and 7.5 mL furfuryl alcohol monomer were added; and the reaction was carried out for 3 h at 70° C. After the reaction was finished, the pH was adjusted to 1.5 by adding 0.1 mol/L NaOH solution; after stirring at room temperature for 2 h, the FePO₄·2H₂O coated with polyfurfuryl alcohol was obtained by filtration, rinsing, and grinding after drying for 5 h at 90° C.

In step 2, the preparation of the lithium iron phosphate coated with carbon layer: the FePO₄·2H₂O coated with polyfurfuryl alcohol was dehydrated at 600° C. for 6 h in a box-type resistance furnace to obtain the FePO₄ coated with polyfurfuryl alcohol; the obtained dehydrated FePO₄ coated with polyfurfuryl alcohol, 0.308 mol of lithium acetate, 0.708 mol of lithium hydroxide, 7 g of glucose, and 7 g of polyethylene glycol (PEG) were fed into a ball mill; 200 mL of anhydrous ethanol was added as the dispersant; the precursor slurry was obtained by grinding with 2 mm zirconium balls for 2.5 h; the precursor slurry was placed in a microwave oven for drying; the slurry was then transferred to a tube-type resistance furnace protected by an N₂ atmosphere; and sintering was carried out at 695° C. for 6.5 h, to prepare the lithium iron phosphate coated with carbon layer.

### 2. Preparation of Lithium-Ion Batteries

Adopting the lithium iron phosphate coated with carbon layer prepared in the present example as the positive electrode active material, the preparation of the lithium-ion battery of the present example is carried out with reference to the scheme for preparing the lithium-ion battery adopted in Example 1, and except for the lithium iron phosphate coated with carbon layer adopted as the positive electrode active material, the other materials used for preparing the lithium-ion battery as well as the proportion and the operation in the present example are all strictly consistent with those corresponding to the descriptions in Example 1.

### 3. Raman Spectroscopy

Raman Spectroscopy using the lithium iron phosphate positive electrode active material coated with carbon layer prepared in the present example was strictly consistent with the corresponding descriptions in Example 1.

### Example 6

### 1. Preparation of Lithium Iron Phosphate Coated with Carbon Layer

In step 1, the preparation of precursor FePO₄: 0.965 mol ferrous sulfate heptahydrate (FeSO₄·7H₂O) was dissolved in 100 mL of deionized water; 100 mL of phosphoric acid solution at a concentration of 10 mol/L, 100 mL of hydrogen peroxide at a concentration of 30% (mass fraction) and 8.5 mL furfuryl alcohol monomer were added; and the reaction was carried out for 3 h at 70° C. After the reaction was finished, the pH was adjusted to 1.5 by adding 0.1 mol/L NaOH solution; after stirring at room temperature for 2 h, the FePO₄·2H₂O coated with polyfurfuryl alcohol was obtained by filtration, rinsing, and grinding after drying for 5 h at 90° C.

In step 2, the preparation of the lithium iron phosphate coated with carbon layer: the FePO₄·2H₂O coated with polyfurfuryl alcohol was dehydrated at 600° C. for 6.5 h in a box-type resistance furnace to obtain the FePO₄ coated with polyfurfuryl alcohol; the obtained dehydrated FePO₄ coated with polyfurfuryl alcohol, 0.308 mol of lithium acetate, 0.708 mol of lithium hydroxide, 7 g of glucose, and 7 g of polyethylene glycol (PEG) were fed into a ball mill; 200 mL of anhydrous ethanol was added as the dispersant; the precursor slurry was obtained by grinding with 2 mm zirconium balls for 2 h; the precursor slurry was placed in a microwave oven for drying; the slurry was then transferred to a tube-type resistance furnace protected by an N₂ atmosphere; and sintering was carried out at 695° C. for 6 h, to prepare the lithium iron phosphate coated with carbon layer.

### 2. Preparation of Lithium-Ion Batteries

Adopting the lithium iron phosphate coated with carbon layer prepared in the present example as the positive electrode active material, the preparation of the lithium-ion battery of the present example is carried out with reference to the scheme for preparing the lithium-ion battery adopted in Example 1, and except for the lithium iron phosphate coated with carbon layer adopted as the positive electrode active material, the other materials used for preparing the lithium-ion battery as well as the proportion and the operation in the present example are all strictly consistent with those corresponding to the descriptions in Example 1.

### 3. Raman Spectroscopy

Raman Spectroscopy using the lithium iron phosphate positive electrode active material coated with carbon layer prepared in the present example was strictly consistent with the corresponding descriptions in Example 1.

### Example 7

### 1. Preparation of Lithium Iron Phosphate Coated with Carbon Layer

In step 1, the preparation of precursor FePO₄: 0.965 mol ferrous sulfate heptahydrate (FeSO₄·7H₂O) was dissolved in 100 mL of deionized water; 100 mL of phosphoric acid solution at a concentration of 10 mol/L, 100 mL of hydrogen peroxide at a concentration of 30% (mass fraction) and 6.5 mL furfuryl alcohol monomer were added; and the reaction was carried out for 3 h at 70° C. After the reaction was finished, the pH was adjusted to 1.5 by adding 0.1 mol/L NaOH solution; after stirring at room temperature for 2 h, the FePO₄·2H₂O coated with polyfurfuryl alcohol was obtained by filtration, rinsing, and grinding after drying for 5 h at 90° C.

In step 2, the preparation of the lithium iron phosphate coated with carbon layer: the FePO₄·2H₂O coated with polyfurfuryl alcohol was dehydrated at 600° C. for 6.5 h in a box-type resistance furnace to obtain the FePO₄ coated with polyfurfuryl alcohol; the obtained dehydrated FePO₄ coated with polyfurfuryl alcohol, 0.308 mol of lithium acetate, 0.708 mol of lithium hydroxide, 7 g of glucose, and 7 g of polyethylene glycol (PEG) were fed into a ball mill; 200 mL of anhydrous ethanol was added as the dispersant; the precursor slurry was obtained by grinding with 2 mm zirconium balls for 2 h; the precursor slurry was placed in a microwave oven for drying; the slurry was then transferred to a tube-type resistance furnace protected by an N₂ atmosphere; and sintering was carried out at 695° C. for 6 h, to prepare the lithium iron phosphate coated with carbon layer.

### 2. Preparation of Lithium-Ion Batteries

Adopting the lithium iron phosphate coated with carbon layer prepared in the present example as the positive electrode active material, the preparation of the lithium-ion battery of the present example is carried out with reference to the scheme for preparing the lithium-ion battery adopted in Example 1, and except for the lithium iron phosphate coated with carbon layer adopted as the positive electrode active material, the other materials used for preparing the lithium-ion battery as well as the proportion and the operation in the present example are all strictly consistent with those corresponding to the descriptions in Example 1.

### 3. Raman Spectroscopy

Raman Spectroscopy using the lithium iron phosphate positive electrode active material coated with carbon layer prepared in the present example was strictly consistent with the corresponding descriptions in Example 1.

### Example 8

### 1. Preparation of Lithium Iron Phosphate Coated with Carbon Layer

In step 1, the preparation of precursor FePO₄: 0.965 mol ferrous sulfate heptahydrate (FeSO₄·7H₂O) was dissolved in 100 mL of deionized water; 100 mL of phosphoric acid solution at a concentration of 10 mol/L, 100 mL of hydrogen peroxide at a concentration of 30% (mass fraction) and 7.5 mL furfuryl alcohol monomer were added; and the reaction was carried out for 3 h at 70° C. After the reaction was finished, the pH was adjusted to 1.5 by adding 0.1 mol/L NaOH solution; after stirring at room temperature for 2 h, the FePO₄·2H₂O coated with polyfurfuryl alcohol was obtained by filtration, rinsing, and grinding after drying for 5 h at 90° C.

In step 2, the preparation of the lithium iron phosphate coated with carbon layer: the FePO₄·2H₂O coated with polyfurfuryl alcohol was dehydrated at 600° C. for 6 h in a box-type resistance furnace to obtain the FePO₄ coated with polyfurfuryl alcohol; the obtained dehydrated FePO₄ coated with polyfurfuryl alcohol, 0.308 mol of lithium acetate, 0.708 mol of lithium hydroxide, 8 g of glucose, and 7 g of polyethylene glycol (PEG) were fed into a ball mill; 200 mL of anhydrous ethanol was added as the dispersant; the precursor slurry was obtained by grinding with 2 mm zirconium balls for 2 h; the precursor slurry was placed in a microwave oven for drying; the slurry was then transferred to a tube-type resistance furnace protected by an N₂ atmosphere; and sintering was carried out at 695° C. for 6.5 h, to prepare the lithium iron phosphate coated with carbon layer.

### 2. Preparation of Lithium-Ion Batteries

Adopting the lithium iron phosphate coated with carbon layer prepared in the present example as the positive electrode active material, the preparation of the lithium-ion battery of the present example is carried out with reference to the scheme for preparing the lithium-ion battery adopted in Example 1, and except for the lithium iron phosphate coated with carbon layer adopted as the positive electrode active material, the other materials used for preparing the lithium-ion battery as well as the proportion and the operation in the present example are all strictly consistent with those corresponding to the descriptions in Example 1.

### 3. Raman Spectroscopy

Raman Spectroscopy using the lithium iron phosphate positive electrode active material coated with carbon layer prepared in the present example was strictly consistent with the corresponding descriptions in Example 1.

### Example 9

### 1. Preparation of Lithium Iron Phosphate Coated with Carbon Layer

In step 1, the preparation of precursor FePO₄: 0.965 mol ferrous sulfate heptahydrate (FeSO₄·7H₂O) was dissolved in 100 mL of deionized water; 100 mL of phosphoric acid solution at a concentration of 10 mol/L, 100 mL of hydrogen peroxide at a concentration of 30% (mass fraction) and 7.5 mL furfuryl alcohol monomer were added; and the reaction was carried out for 3 h at 70° C. After the reaction was finished, the pH was adjusted to 1.5 by adding 0.1 mol/L NaOH solution; after stirring at room temperature for 2 h, the FePO₄·2H₂O coated with polyfurfuryl alcohol was obtained by filtration, rinsing, and grinding after drying for 5 h at 90° C.

In step 2, the preparation of the lithium iron phosphate coated with carbon layer: the FePO₄·2H₂O coated with polyfurfuryl alcohol was dehydrated at 600° C. for 6 h in a box-type resistance furnace to obtain the FePO₄ coated with polyfurfuryl alcohol; the obtained dehydrated FePO₄ coated with polyfurfuryl alcohol, 0.308 mol of lithium acetate, 0.708 mol of lithium hydroxide, 6 g of glucose, and 7 g of polyethylene glycol (PEG) were fed into a ball mill; 200 mL of anhydrous ethanol was added as the dispersant; the precursor slurry was obtained by grinding with 2 mm zirconium balls for 2 h; the precursor slurry was placed in a microwave oven for drying; the slurry was then transferred to a tube-type resistance furnace protected by an N₂ atmosphere; and sintering was carried out at 695° C. for 6.5 h, to prepare the lithium iron phosphate coated with carbon layer.

### 2. Preparation of Lithium-Ion Batteries

Adopting the lithium iron phosphate coated with carbon layer prepared in the present example as the positive electrode active material, the preparation of the lithium-ion battery of the present example is carried out with reference to the scheme for preparing the lithium-ion battery adopted in Example 1, and except for the lithium iron phosphate coated with carbon layer adopted as the positive electrode active material, the other materials used for preparing the lithium-ion battery as well as the proportion and the operation in the present example are all strictly consistent with those corresponding to the descriptions in Example 1.

### 3. Raman Spectroscopy

Raman Spectroscopy using the lithium iron phosphate positive electrode active material coated with carbon layer prepared in the present example was strictly consistent with the corresponding descriptions in Example 1.

### Example 10

### 1. Preparation of Lithium Iron Phosphate Coated with Carbon Layer

In step 1, the preparation of precursor FePO₄: 0.965 mol ferrous sulfate heptahydrate (FeSO₄·7H₂O) was dissolved in 100 mL of deionized water; 100 mL of phosphoric acid solution at a concentration of 10 mol/L, 100 mL of hydrogen peroxide at a concentration of 30% (mass fraction) and 7.5 mL furfuryl alcohol monomer were added; and the reaction was carried out for 3 h at 70° C. After the reaction was finished, the pH was adjusted to 1.5 by adding 0.1 mol/L NaOH solution; after stirring at room temperature for 2 h, the FePO₄·2H₂O coated with polyfurfuryl alcohol was obtained by filtration, rinsing, and grinding after drying for 5 h at 90° C.

In step 2, the preparation of the lithium iron phosphate coated with carbon layer: the FePO₄·2H₂O coated with polyfurfuryl alcohol was dehydrated at 600° C. for 6 h in a box-type resistance furnace to obtain the FePO₄ coated with polyfurfuryl alcohol; the obtained dehydrated FePO₄ coated with polyfurfuryl alcohol, 0.308 mol of lithium acetate, 0.708 mol of lithium hydroxide, 7 g of glucose, and 8 g of polyethylene glycol (PEG) were fed into a ball mill; 200 mL of anhydrous ethanol was added as the dispersant; the precursor slurry was obtained by grinding with 2 mm zirconium balls for 2 h; the precursor slurry was placed in a microwave oven for drying; the slurry was then transferred to a tube-type resistance furnace protected by an N₂ atmosphere; and sintering was carried out at 695° C. for 6.5 h, to prepare the lithium iron phosphate coated with carbon layer.

### 2. Preparation of Lithium-Ion Batteries

Adopting the lithium iron phosphate coated with carbon layer prepared in the present example as the positive electrode active material, the preparation of the lithium-ion battery of the present example is carried out with reference to the scheme for preparing the lithium-ion battery adopted in Example 1, and except for the lithium iron phosphate coated with carbon layer adopted as the positive electrode active material, the other materials used for preparing the lithium-ion battery as well as the proportion and the operation in the present example are all strictly consistent with those corresponding to the descriptions in Example 1.

### 3. Raman Spectroscopy

Raman Spectroscopy using the lithium iron phosphate positive electrode active material coated with carbon layer prepared in the present example was strictly consistent with the corresponding descriptions in Example 1.

### Example 11

### 1. Preparation of Lithium Iron Phosphate Coated with Carbon Layer

In step 1, the preparation of precursor FePO₄: 0.965 mol ferrous sulfate heptahydrate (FeSO₄·7H₂O) was dissolved in 100 mL of deionized water; 100 mL of phosphoric acid solution at a concentration of 10 mol/L, 100 mL of hydrogen peroxide at a concentration of 30% (mass fraction) and 7.5 mL furfuryl alcohol monomer were added; and the reaction was carried out for 3 h at 70° C. After the reaction was finished, the pH was adjusted to 1.5 by adding 0.1 mol/L NaOH solution; after stirring at room temperature for 2 h, the FePO₄·2H₂O coated with polyfurfuryl alcohol was obtained by filtration, rinsing, and grinding after drying for 5 h at 90° C.

In step 2, the preparation of the lithium iron phosphate coated with carbon layer: the FePO₄·2H₂O coated with polyfurfuryl alcohol was dehydrated at 600° C. for 6 h in a box-type resistance furnace to obtain the FePO₄ coated with polyfurfuryl alcohol; the obtained dehydrated FePO₄ coated with polyfurfuryl alcohol, 0.308 mol of lithium acetate, 0.708 mol of lithium hydroxide, 7 g of glucose, and 6 g of polyethylene glycol (PEG) were fed into a ball mill; 200 mL of anhydrous ethanol was added as the dispersant; the precursor slurry was obtained by grinding with 2 mm zirconium balls for 2 h; the precursor slurry was placed in a microwave oven for drying; the slurry was then transferred to a tube-type resistance furnace protected by an N₂ atmosphere; and sintering was carried out at 695° C. for 6.5 h, to prepare the lithium iron phosphate coated with carbon layer.

### 2. Preparation of Lithium-Ion Batteries

Adopting the lithium iron phosphate coated with carbon layer prepared in the present example as the positive electrode active material, the preparation of the lithium-ion battery of the present example is carried out with reference to the scheme for preparing the lithium-ion battery adopted in Example 1, and except for the lithium iron phosphate coated with carbon layer adopted as the positive electrode active material, the other materials used for preparing the lithium-ion battery as well as the proportion and the operation in the present example are all strictly consistent with those corresponding to the descriptions in Example 1.

### 3. Raman Spectroscopy

Raman Spectroscopy using the lithium iron phosphate positive electrode active material coated with carbon layer prepared in the present example was strictly consistent with the corresponding descriptions in Example 1.

### Example 12

### 1. Preparation of Lithium Iron Phosphate Coated with Carbon Layer

In step 1, the preparation of precursor FePO₄: 0.965 mol ferrous sulfate heptahydrate (FeSO₄·7H₂O) was dissolved in 100 mL of deionized water; 100 mL of phosphoric acid solution at a concentration of 10 mol/L, 100 mL of hydrogen peroxide at a concentration of 30% (mass fraction) and 7.5 mL furfuryl alcohol monomer were added; and the reaction was carried out for 3 h at 70° C. After the reaction was finished, the pH was adjusted to 1.5 by adding 0.1 mol/L NaOH solution; after stirring at room temperature for 2 h, the FePO₄·2H₂O coated with polyfurfuryl alcohol was obtained by filtration, rinsing, and grinding after drying for 5 h at 90° C.

In step 2, the preparation of the lithium iron phosphate coated with carbon layer: the FePO₄·2H₂O coated with polyfurfuryl alcohol was dehydrated at 600° C. for 6.5 h in a box-type resistance furnace to obtain the FePO₄ coated with polyfurfuryl alcohol; the obtained dehydrated FePO₄ coated with polyfurfuryl alcohol, 0.308 mol of lithium acetate, 0.708 mol of lithium hydroxide, 6 g of glucose, and 6 g of polyethylene glycol (PEG) were fed into a ball mill; 200 mL of anhydrous ethanol was added as the dispersant; the precursor slurry was obtained by grinding with 2 mm zirconium balls for 2 h; the precursor slurry was placed in a microwave oven for drying; the slurry was then transferred to a tube-type resistance furnace protected by an N₂ atmosphere; and sintering was carried out at 695° C. for 6 h, to prepare the lithium iron phosphate coated with carbon layer.

### 2. Preparation of Lithium-Ion Batteries

Adopting the lithium iron phosphate coated with carbon layer prepared in the present example as the positive electrode active material, the preparation of the lithium-ion battery of the present example is carried out with reference to the scheme for preparing the lithium-ion battery adopted in Example 1, and except for the lithium iron phosphate coated with carbon layer adopted as the positive electrode active material, the other materials used for preparing the lithium-ion battery as well as the proportion and the operation in the present example are all strictly consistent with those corresponding to the descriptions in Example 1.

### 3. Raman Spectroscopy

Raman Spectroscopy using the lithium iron phosphate positive electrode active material coated with carbon layer prepared in the present example was strictly consistent with the corresponding descriptions in Example 1.

### Example 13

### 1. Preparation of Lithium Iron Phosphate Coated with Carbon Layer

In step 1, the preparation of precursor FePO₄: 0.965 mol ferrous sulfate heptahydrate (FeSO₄·7H₂O) was dissolved in 100 mL of deionized water; 100 mL of phosphoric acid solution at a concentration of 10 mol/L, 100 mL of hydrogen peroxide at a concentration of 30% (mass fraction) and 7.5 mL furfuryl alcohol monomer were added; and the reaction was carried out for 3 h at 70° C. After the reaction was finished, the pH was adjusted to 1.5 by adding 0.1 mol/L NaOH solution; after stirring at room temperature for 2 h, the FePO₄·2H₂O coated with polyfurfuryl alcohol was obtained by filtration, rinsing, and grinding after drying for 5 h at 90° C.

In step 2, the preparation of the lithium iron phosphate coated with carbon layer: the FePO₄·2H₂O coated with polyfurfuryl alcohol was dehydrated at 600° C. for 6.5 h in a box-type resistance furnace to obtain the FePO₄ coated with polyfurfuryl alcohol; the obtained dehydrated FePO₄ coated with polyfurfuryl alcohol, 0.308 mol of lithium acetate, 0.708 mol of lithium hydroxide, 10 g of glucose, and 10 g of polyethylene glycol (PEG) were fed into a ball mill; 200 mL of anhydrous ethanol was added as the dispersant; the precursor slurry was obtained by grinding with 2 mm zirconium balls for 2 h; the precursor slurry was placed in a microwave oven for drying; the slurry was then transferred to a tube-type resistance furnace protected by an N₂ atmosphere; and sintering was carried out at 695° C. for 6 h, to prepare the lithium iron phosphate coated with carbon layer.

### 2. Preparation of Lithium-Ion Batteries

Adopting the lithium iron phosphate coated with carbon layer prepared in the present example as the positive electrode active material, the preparation of the lithium-ion battery of the present example is carried out with reference to the scheme for preparing the lithium-ion battery adopted in Example 1, and except for the lithium iron phosphate coated with carbon layer adopted as the positive electrode active material, the other materials used for preparing the lithium-ion battery as well as the proportion and the operation in the present example are all strictly consistent with those corresponding to the descriptions in Example 1.

### 3. Raman Spectroscopy

Raman Spectroscopy using the lithium iron phosphate positive electrode active material coated with carbon layer prepared in the present example was strictly consistent with the corresponding descriptions in Example 1.

### Example 14

### 1. Preparation of Lithium Iron Phosphate Coated with Carbon Layer

In step 1, the preparation of precursor FePO₄: 0.965 mol ferrous sulfate heptahydrate (FeSO₄·7H₂O) was dissolved in 100 mL of deionized water; 100 mL of phosphoric acid solution at a concentration of 10 mol/L, 100 mL of hydrogen peroxide at a concentration of 30% (mass fraction) and 7.5 mL furfuryl alcohol monomer were added; and the reaction was carried out for 3 h at 70° C. After the reaction was finished, the pH was adjusted to 1.5 by adding 0.1 mol/L NaOH solution; after stirring at room temperature for 2 h, the FePO₄·2H₂O coated with polyfurfuryl alcohol was obtained by filtration, rinsing, and grinding after drying for 5 h at 90° C.

In step 2, the preparation of the lithium iron phosphate coated with carbon layer: the FePO₄·2H₂O coated with polyfurfuryl alcohol was dehydrated at 600° C. for 6 h in a box-type resistance furnace to obtain the FePO₄ coated with polyfurfuryl alcohol; the obtained dehydrated FePO₄ coated with polyfurfuryl alcohol, 0.308 mol of lithium acetate, 0.708 mol of lithium hydroxide, 4 g of glucose, and 4 g of polyethylene glycol (PEG) were fed into a ball mill; 200 mL of anhydrous ethanol was added as the dispersant; the precursor slurry was obtained by grinding with 2 mm zirconium balls for 2 h; the precursor slurry was placed in a microwave oven for drying; the slurry was then transferred to a tube-type resistance furnace protected by an N₂ atmosphere; and sintering was carried out at 695° C. for 6.5 h, to prepare the lithium iron phosphate coated with carbon layer.

### 2. Preparation of Lithium-Ion Batteries

Adopting the lithium iron phosphate coated with carbon layer prepared in the present example as the positive electrode active material, the preparation of the lithium-ion battery of the present example is carried out with reference to the scheme for preparing the lithium-ion battery adopted in Example 1, and except for the lithium iron phosphate coated with carbon layer adopted as the positive electrode active material, the other materials used for preparing the lithium-ion battery as well as the proportion and the operation in the present example are all strictly consistent with those corresponding to the descriptions in Example 1.

### 3. Raman Spectroscopy

Raman Spectroscopy using the lithium iron phosphate positive electrode active material coated with carbon layer prepared in the present example was strictly consistent with the corresponding descriptions in Example 1.

### Example 15

### 1. Preparation of Lithium Iron Phosphate Coated with Carbon Layer

In step 1, the preparation of precursor FePO₄: 0.965 mol ferrous sulfate heptahydrate (FeSO₄·7H₂O) was dissolved in 100 mL of deionized water; 100 mL of phosphoric acid solution at a concentration of 10 mol/L, 100 mL of hydrogen peroxide at a concentration of 30% (mass fraction) and 8.5 mL furfuryl alcohol monomer were added; and the reaction was carried out for 3 h at 70° C. After the reaction was finished, the pH was adjusted to 1.5 by adding 0.1 mol/L NaOH solution; after stirring at room temperature for 2 h, the FePO₄·2H₂O coated with polyfurfuryl alcohol was obtained by filtration, rinsing, and grinding after drying for 5 h at 90° C.

In step 2, the preparation of the lithium iron phosphate coated with carbon layer: the FePO₄·2H₂O coated with polyfurfuryl alcohol was dehydrated at 600° C. for 6 h in a box-type resistance furnace to obtain the FePO₄ coated with polyfurfuryl alcohol; the obtained dehydrated FePO₄ coated with polyfurfuryl alcohol, 0.308 mol of lithium acetate, 0.708 mol of lithium hydroxide, 7 g of glucose, and 7 g of polyethylene glycol (PEG) were fed into a ball mill; 200 mL of anhydrous ethanol was added as the dispersant; the precursor slurry was obtained by grinding with 2 mm zirconium balls for 1 h; the precursor slurry was placed in a microwave oven for drying; the slurry was then transferred to a tube-type resistance furnace protected by an N₂ atmosphere; and sintering was carried out at 680° C. for 6 h, to prepare the lithium iron phosphate coated with carbon layer.

### 2. Preparation of Lithium-Ion Batteries

Adopting the lithium iron phosphate coated with carbon layer prepared in the present example as the positive electrode active material, the preparation of the lithium-ion battery of the present example is carried out with reference to the scheme for preparing the lithium-ion battery adopted in Example 1, and except for the lithium iron phosphate coated with carbon layer adopted as the positive electrode active material, the other materials used for preparing the lithium-ion battery as well as the proportion and the operation in the present example are all strictly consistent with those corresponding to the descriptions in Example 1.

### 3. Raman Spectroscopy

Raman Spectroscopy using the lithium iron phosphate positive electrode active material coated with carbon layer prepared in the present example was strictly consistent with the corresponding descriptions in Example 1.

### Example 16

### 1. Preparation of Lithium Iron Phosphate Coated with Carbon Layer

In step 1, the preparation of precursor FePO₄: 0.965 mol ferrous sulfate heptahydrate (FeSO₄·7H₂O) was dissolved in 100 mL of deionized water; 100 mL of phosphoric acid solution at a concentration of 10 mol/L, 100 mL of hydrogen peroxide at a concentration of 30% (mass fraction) and 6 mL furfuryl alcohol monomer were added; and the reaction was carried out for 3 h at 70° C. After the reaction was finished, the pH was adjusted to 1.5 by adding 0.1 mol/L NaOH solution; after stirring at room temperature for 2 h, the FePO₄·2H₂O coated with polyfurfuryl alcohol was obtained by filtration, rinsing, and grinding after drying for 5 h at 90° C.

In step 2, the preparation of the lithium iron phosphate coated with carbon layer: the FePO₄·2H₂O coated with polyfurfuryl alcohol was dehydrated at 600° C. for 6 h in a box-type resistance furnace to obtain the FePO₄ coated with polyfurfuryl alcohol; the obtained dehydrated FePO₄ coated with polyfurfuryl alcohol, 0.308 mol of lithium acetate, 0.708 mol of lithium hydroxide, 7 g of glucose, and 7 g of polyethylene glycol (PEG) were fed into a ball mill; 200 mL of anhydrous ethanol was added as the dispersant; the precursor slurry was obtained by grinding with 2 mm zirconium balls for 3 h; the precursor slurry was placed in a microwave oven for drying; the slurry was then transferred to a tube-type resistance furnace protected by an N₂ atmosphere; and sintering was carried out at 710° C. for 8 h, to prepare the lithium iron phosphate coated with carbon layer.

### 2. Preparation of Lithium-Ion Batteries

Adopting the lithium iron phosphate coated with carbon layer prepared in the present example as the positive electrode active material, the preparation of the lithium-ion battery of the present example is carried out with reference to the scheme for preparing the lithium-ion battery adopted in Example 1, and except for the lithium iron phosphate coated with carbon layer adopted as the positive electrode active material, the other materials used for preparing the lithium-ion battery as well as the proportion and the operation in the present example are all strictly consistent with those corresponding to the descriptions in Example 1.

### 3. Raman Spectroscopy

Raman Spectroscopy using the lithium iron phosphate positive electrode active material coated with carbon layer prepared in the present example was strictly consistent with the corresponding descriptions in Example 1.

### Contrast Example 1

### 1. Preparation of Lithium Iron Phosphate Coated with Carbon Layer

In step 1, the preparation of precursor FePO₄: 0.965 mol ferrous sulfate heptahydrate (FeSO₄·7H₂O) was dissolved in 100 mL of deionized water; 100 mL of phosphoric acid solution at a concentration of 10 mol/L, 100 mL of hydrogen peroxide at a concentration of 30% (mass fraction) and 5.5 mL furfuryl alcohol monomer were added; and the reaction was carried out for 3 h at 70° C. After the reaction was finished, the pH was adjusted to 1.5 by adding 0.1 mol/L NaOH solution; after stirring at room temperature for 2 h, the FePO₄·2H₂O coated with polyfurfuryl alcohol was obtained by filtration, rinsing, and grinding after drying for 5 h at 90° C.

In step 2, the preparation of the lithium iron phosphate coated with carbon layer: the FePO₄·2H₂O coated with polyfurfuryl alcohol was dehydrated at 600° C. for 6 h in a box-type resistance furnace to obtain the FePO₄ coated with polyfurfuryl alcohol; the obtained dehydrated FePO₄ coated with polyfurfuryl alcohol, 0.308 mol of lithium acetate, 0.708 mol of lithium hydroxide, 6 g of glucose, and 10 g of polyethylene glycol (PEG) were fed into a ball mill; 200 mL of anhydrous ethanol was added as the dispersant; the precursor slurry was obtained by grinding with 2 mm zirconium balls for 2 h; the precursor slurry was placed in a microwave oven for drying; the slurry was then transferred to a tube-type resistance furnace protected by an N₂ atmosphere; and sintering was carried out at 680° C. for 6 h, to prepare the lithium iron phosphate coated with carbon layer.

Adopting the lithium iron phosphate coated with carbon layer prepared in the present contrast example as the positive electrode active material, the preparation of the lithium-ion battery of the present contrast example is carried out with reference to the scheme for preparing the lithium-ion battery adopted in Example 1, and except for the lithium iron phosphate coated with carbon layer adopted as the positive electrode active material, the other materials used for preparing the lithium-ion battery as well as the proportion and the operation in the present contrast example are all strictly consistent with those corresponding to the descriptions in Example 1.

### 3. Raman Spectroscopy

Raman Spectroscopy using the lithium iron phosphate positive electrode active material coated with carbon layer prepared in the present contrast example was strictly consistent with the corresponding descriptions in Example 1.

### Contrast Example 2

### 1. Preparation of Lithium Iron Phosphate Coated with Carbon Layer

In step 1, the preparation of precursor FePO₄: 0.965 mol ferrous sulfate heptahydrate (FeSO₄·7H₂O) was dissolved in 100 mL of deionized water; 100 mL of phosphoric acid solution at a concentration of 10 mol/L, 100 mL of hydrogen peroxide at a concentration of 30% (mass fraction) and 5 mL furfuryl alcohol monomer were added; and the reaction was carried out for 3 h at 70° C. After the reaction was finished, the pH was adjusted to 1.5 by adding 0.1 mol/L NaOH solution; after stirring at room temperature for 2 h, the FePO₄·2H₂O coated with polyfurfuryl alcohol was obtained by filtration, rinsing, and grinding after drying for 5 h at 90° C.

In step 2, the preparation of the lithium iron phosphate coated with carbon layer: the FePO₄·2H₂O coated with polyfurfuryl alcohol was dehydrated at 600° C. for 6 h in a box-type resistance furnace to obtain the FePO₄ coated with polyfurfuryl alcohol; the obtained dehydrated FePO₄ coated with polyfurfuryl alcohol, 0.308 mol of lithium acetate, 0.708 mol of lithium hydroxide, 6 g of glucose, and 10 g of polyethylene glycol (PEG) were fed into a ball mill; 200 mL of anhydrous ethanol was added as the dispersant; the precursor slurry was obtained by grinding with 2 mm zirconium balls for 2 h; the precursor slurry was placed in a microwave oven for drying; the slurry was then transferred to a tube-type resistance furnace protected by an N₂ atmosphere; and sintering was carried out at 680° C. for 6 h, to prepare the lithium iron phosphate coated with carbon layer.

Adopting the lithium iron phosphate coated with carbon layer prepared in the present contrast example as the positive electrode active material, the preparation of the lithium-ion battery of the present contrast example is carried out with reference to the scheme for preparing the lithium-ion battery adopted in Example 1, and except for the lithium iron phosphate coated with carbon layer adopted as the positive electrode active material, the other materials used for preparing the lithium-ion battery as well as the proportion and the operation in the present contrast example are all strictly consistent with those corresponding to the descriptions in Example 1.

### 3. Raman Spectroscopy

Raman Spectroscopy using the lithium iron phosphate positive electrode active material coated with carbon layer prepared in the present contrast example was strictly consistent with the corresponding descriptions in Example 1.

### Contrast Example 3

### 1. Preparation of Lithium Iron Phosphate Coated with Carbon Layer

In step 1, the preparation of precursor FePO₄: 0.965 mol ferrous sulfate heptahydrate (FeSO₄·7H₂O) was dissolved in 100 mL of deionized water; 100 mL of phosphoric acid solution at a concentration of 10 mol/L, 100 mL of hydrogen peroxide at a concentration of 30% (mass fraction) and 8.5 mL furfuryl alcohol monomer were added; and the reaction was carried out for 3 h at 70° C. After the reaction was finished, the pH was adjusted to 1.5 by adding 0.1 mol/L NaOH solution; after stirring at room temperature for 2 h, the FePO₄·2H₂O coated with polyfurfuryl alcohol was obtained by filtration, rinsing, and grinding after drying for 5 h at 90° C.

In step 2, the preparation of the lithium iron phosphate coated with carbon layer: the FePO₄·2H₂O coated with polyfurfuryl alcohol was dehydrated at 600° C. for 6 h in a box-type resistance furnace to obtain the FePO₄ coated with polyfurfuryl alcohol; the obtained dehydrated FePO₄ coated with polyfurfuryl alcohol, 0.308 mol of lithium acetate, 0.708 mol of lithium hydroxide, 10 g of glucose, and 10 g of polyethylene glycol (PEG) were fed into a ball mill; 200 mL of anhydrous ethanol was added as the dispersant; the precursor slurry was obtained by grinding with 2 mm zirconium balls for 2.5 h; the precursor slurry was placed in a microwave oven for drying; the slurry was then transferred to a tube-type resistance furnace protected by an N₂ atmosphere; and sintering was carried out at 715° C. for 8 h, to prepare the lithium iron phosphate coated with carbon layer.

Adopting the lithium iron phosphate coated with carbon layer prepared in the present contrast example as the positive electrode active material, the preparation of the lithium-ion battery of the present contrast example is carried out with reference to the scheme for preparing the lithium-ion battery adopted in Example 1, and except for the lithium iron phosphate coated with carbon layer adopted as the positive electrode active material, the other materials used for preparing the lithium-ion battery as well as the proportion and the operation in the present contrast example are all strictly consistent with those corresponding to the descriptions in Example 1.

### 3. Raman Spectroscopy

Raman Spectroscopy using the lithium iron phosphate positive electrode active material coated with carbon layer prepared in the present contrast example was strictly consistent with the corresponding descriptions in Example 1.

### Contrast Example 4

### 1. Preparation of Lithium Iron Phosphate Coated with Carbon Layer

In step 1, the preparation of precursor FePO₄: 0.965 mol ferrous sulfate heptahydrate (FeSO₄·7H₂O) was dissolved in 100 mL of deionized water; 100 mL of phosphoric acid solution at a concentration of 10 mol/L, 100 mL of hydrogen peroxide at a concentration of 30% (mass fraction) and 8.5 mL furfuryl alcohol monomer were added; and the reaction was carried out for 3 h at 70° C. After the reaction was finished, the pH was adjusted to 1.5 by adding 0.1 mol/L NaOH solution; after stirring at room temperature for 2 h, the FePO₄·2H₂O coated with polyfurfuryl alcohol was obtained by filtration, rinsing, and grinding after drying for 5 h at 90° C.

In step 2, the preparation of the lithium iron phosphate coated with carbon layer: the FePO₄·2H₂O coated with polyfurfuryl alcohol was dehydrated at 600° C. for 6 h in a box-type resistance furnace to obtain the FePO₄ coated with polyfurfuryl alcohol; the obtained dehydrated FePO₄ coated with polyfurfuryl alcohol, 0.308 mol of lithium acetate, 0.708 mol of lithium hydroxide, 10 g of glucose, and 9 g of polyethylene glycol (PEG) were fed into a ball mill; 200 mL of anhydrous ethanol was added as the dispersant; the precursor slurry was obtained by grinding with 2 mm zirconium balls for 2.5 h; the precursor slurry was placed in a microwave oven for drying; the slurry was then transferred to a tube-type resistance furnace protected by an N₂ atmosphere; and sintering was carried out at 720° C. for 8 h, to prepare the lithium iron phosphate coated with carbon layer.

Adopting the lithium iron phosphate coated with carbon layer prepared in the present contrast example as the positive electrode active material, the preparation of the lithium-ion battery of the present contrast example is carried out with reference to the scheme for preparing the lithium-ion battery adopted in Example 1, and except for the lithium iron phosphate coated with carbon layer adopted as the positive electrode active material, the other materials used for preparing the lithium-ion battery as well as the proportion and the operation in the present contrast example are all strictly consistent with those corresponding to the descriptions in Example 1.

### 3. Raman Spectroscopy

Raman Spectroscopy using the lithium iron phosphate positive electrode active material coated with carbon layer prepared in the present contrast example was strictly consistent with the corresponding descriptions in Example 1.

### Contrast Example 5

### 1. Preparation of Lithium Iron Manganese Phosphate Coated with Carbon Layer

In step 1, the preparation of precursor FePO₄: 0.965 mol ferrous sulfate heptahydrate (FeSO₄·7H₂O) was dissolved in 100 mL of deionized water; 100 mL of phosphoric acid solution at a concentration of 10 mol/L, 100 mL of hydrogen peroxide at a concentration of 30% (mass fraction) and 7.5 mL furfuryl alcohol monomer were added; and the reaction was carried out for 3 h at 70° C. After the reaction was finished, the pH was adjusted to 1.5 by adding 0.1 mol/L NaOH solution; after stirring at room temperature for 2 h, the FePO₄·2H₂O coated with polyfurfuryl alcohol was obtained by filtration, rinsing, and grinding after drying for 5 h at 90° C.

In step 2, the preparation of the lithium iron manganese phosphate coated with carbon layer: the FePO₄·2H₂O coated with polyfurfuryl alcohol was dehydrated at 600° C. for 6 h in a box-type resistance furnace to obtain the FePO₄ coated with polyfurfuryl alcohol; the obtained dehydrated FePO₄ coated with polyfurfuryl alcohol, 0.308 mol of lithium acetate, 0.708 mol of lithium hydroxide, 7 g of glucose, 7 g of polyethylene glycol (PEG), and 20 g of MnO₂ were fed into a ball mill; 200 mL of anhydrous ethanol was added as the dispersant; the precursor slurry was obtained by grinding with 2 mm zirconium balls for 2 h; the precursor slurry was placed in a microwave oven for drying; the slurry was then transferred to a tube-type resistance furnace protected by an N₂ atmosphere; and sintering was carried out at 695° C. for 6.5 h, to prepare the lithium iron manganese phosphate coated with carbon layer.

The lithium iron manganese phosphate coated with carbon layer prepared in the present contrast example showed an I_{D}/I_{G} value of 0.91, a thickness of the carbon layer of 3.6 nm, and a D₅₀ of 1.22 m.

### 2. Preparation of Lithium-Ion Batteries

Adopting the lithium iron manganese phosphate coated with carbon layer prepared in the present contrast example as the positive electrode active material, the preparation of the lithium-ion battery of the present contrast example is carried out with reference to the scheme for preparing the lithium-ion battery adopted in Example 1, and except for the lithium iron manganese phosphate coated with carbon layer adopted as the positive electrode active material, the other materials used for preparing the lithium-ion battery as well as the proportion and the operation in the present contrast example are all strictly consistent with those corresponding to the descriptions in Example 1.

### 3. Raman Spectroscopy

Raman Spectroscopy using the lithium iron manganese phosphate positive electrode active material coated with carbon layer prepared in the present contrast example was strictly consistent with the corresponding descriptions in Example 1.

The I_{D}/I_{G} value, thickness of the carbon layer, and D50 of the lithium iron phosphate coated with carbon layer prepared in Examples 1-16 and Contrast Examples 1-5 are shown in Table 1 below.

TABLE 1

| | | Carbon layer | D₅₀ (μm) |
|---|---|---|---|
| | I_{D}/I_{G} of the | thickness | of the |
| | lithium iron | (nm) of the | lithium |
| | phosphate | lithium iron | iron phosphate |
| | coated | phosphate | coated |
| | with | coated with | with carbon |
| Groups | carbon layer | carbon layer | layer |
| Example 1 | 0.90 | 3.5 | 1.20 |
| Example 2 | 0.97 | 3.0 | 1.04 |
| Example 3 | 0.85 | 3.8 | 1.28 |
| Example 4 | 0.89 | 4.1 | 1.26 |
| Example 5 | 0.91 | 3.2 | 1.14 |
| Example 6 | 1.13 | 3.9 | 1.32 |
| Example 7 | 0.81 | 2.9 | 1.15 |
| Example 8 | 1.06 | 4.2 | 1.25 |
| Example 9 | 0.82 | 2.7 | 1.09 |
| Example 10 | 0.79 | 4.6 | 1.35 |
| Example 11 | 1.05 | 3.1 | 0.98 |
| Example 12 | 1.21 | 2.3 | 0.87 |
| Example 13 | 0.96 | 7.2 | 1.56 |
| Example 14 | 1.17 | 1.6 | 0.81 |
| Example 15 | 1.02 | 5.1 | 1.67 |
| Example 16 | 0.93 | 2.3 | 0.69 |
| Contrast | 0.69 | 4.3 | 1.43 |
| Example 1 | | | |
| Contrast | 0.62 | 4.1 | 1.37 |
| Example 2 | | | |
| Contrast | 1.29 | 3.9 | 1.52 |
| Example 3 | | | |
| Contrast | 1.32 | 3.3 | 1.48 |
| Example 4 | | | |
| Contrast | 0.91 | 3.6 | 1.22 |
| Example 5 | | | |

### Performance Test

### (1) Resistance of Charge Transfer (R_{ct}) Test:

The Reference 600 electrochemical workstation manufactured by GAMRY Instruments, Inc. in USA is employed to carry out the starting electrochemical impedance spectroscopy test, with lithium metal as the counter electrode and reference electrode, and the active material electrode sheet as the working electrode. Tests are performed in a 28° C. environment with a scanning frequency of 100 KHz to 0.01 Hz and a scanning amplitude of 5 mV. Charge transfer impedance and lithium-ion diffusion rate D_{L}u in the electrochemical behavior of lithium iron phosphate cathode materials are studied by testing the electrochemical impedance spectra of the material. D_{L}, is calculated using the following equation:

$${D}_{L i} = {R}^{2} {T}^{2} / 2 {A}^{2} {n}^{4} {F}^{4} {C}^{2} {σ}^{2}$$

R—molecular gas constant, 8.314 Pa·m³·mol⁻¹·K⁻¹
T—absolute temperature (K)
A—surface area of cathode material (m²)
n—number of electrons transferred per mole of active substance
F—Faraday constant (6485.3383±0.0083C/mol)
C—Lithium-ion concentration (mol/L)
σ—Warburg Coefficient

The real part of the electrochemical impedance is related to a by the equation:

$${Z}_{R e} = {R}_{Ω} + {R}_{c t} + {R}_{w} = {R}_{Ω} + {R}_{c t} + σ \cdot {ω}^{- 1 / 2}$$

R_{Ω} is the ohmic impedance, R_{ct} is the charge transfer impedance, and Rw is the Warburg impedance. The Warburg Coefficient σ is numerically equal to the slope of a line fitted by the real part of the electrochemical impedance (Z_{Re}) and the inverse of the square root of the angular frequency (ω^{-1/2})

### (2) Test of the First Discharge Capacity Per Gram

Button cells were prepared to perform charge/discharge tests with a lithium-ion battery charge/discharge test system at −20±0.5° C. Charge cutoff voltage of 3.75V; discharge cutoff voltage of 2.00 V; charge/discharge current density of 2C (nominal specific capacity of 150 mAh/g).

The performance test results are shown in Table 2.

TABLE 2

| | | | First discharge |
|---|---|---|---|
| | | | capacity |
| | | | per gram |
| | | Li⁺ | (mAh/g) at- |
| | | diffusion | 20° C. with a |
| | | coefficient | charge/discharge |
| Groups | R_{ct} (Ω) | (cm²/s) | current density 2 C |
| Example 1 | 82.9 | 9.33 × 10⁻¹¹ | 88.7 |
| Example 2 | 84.3 | 8.76 × 10⁻¹¹ | 87.4 |
| Example 3 | 89.1 | 5.21 × 10⁻¹¹ | 83.4 |
| Example 4 | 84.2 | 8.93 × 10⁻¹¹ | 87.8 |
| Example 5 | 85.3 | 7.88 × 10⁻¹¹ | 86.3 |
| Example 6 | 99.9 | 9.78 × 10⁻¹² | 76.7 |
| Example 7 | 87.3 | 5.66 × 10⁻¹¹ | 84.9 |
| Example 8 | 96.5 | 1.69 × 10−¹¹ | 78.3 |
| Example 9 | 89.3 | 5.05 × 10⁻¹¹ | 82.9 |
| Example 10 | 122.3 | 3.18 × 10⁻¹² | 67.2 |
| Example 11 | 126.5 | 1.31 × 10⁻¹² | 64.9 |
| Example 12 | 123.6 | 2.85 × 10⁻¹² | 66.5 |
| Example 13 | 94.5 | 3.11 × 10⁻¹¹ | 81.2 |
| Example 14 | 125.6 | 2.13 × 10⁻¹² | 65.7 |
| Example 15 | 133.6 | 9.52 × 10⁻¹³ | 62.8 |
| Example 16 | 95.7 | 2.51 × 10⁻¹¹ | 79.5 |
| Contrast | 143.4 | 7.72 × 10⁻¹³ | 58.2 |
| Example 1 | | | |
| Contrast | 136.7 | 8.97 × 10⁻¹³ | 61.9 |
| Example 2 | | | |
| Contrast | 227.1 | 1.04 × 10⁻¹³ | 42.6 |
| Example 3 | | | |
| Contrast | 153.4 | 6.75 × 10⁻¹³ | 54.4 |
| Example 4 | | | |
| Contrast | 177.1 | 4.13 × 10⁻¹³ | 48.9 |
| Example 5 | | | |

As shown in Tables 1 and 2:
1. The lithium iron phosphate coated with carbon layer prepared in Examples 1-5, 7, 9, 13, and 16 showed I_{D}/I_{G} values in a more preferred range of 0.8-1.0, with resistance of charge transfer (Rₜ), lithium-ion diffusion rate D_{Li}, and the first discharge capacity per gram at a low temperature of −20° C. with a charge/discharge current density 2C superior to the other Examples. The above results fully validated that the lithium iron phosphate coated with carbon layer showed an I_{D}/I_{G} value of 0.8-1.0, with an I_{D}/I_{G} value in such a range, which further improves the desolvation rate of Li⁺ at the interface between the electrode and the electrolyte and enhances the desolvation ability, thereby increasing the electrical conductivity as well as rate performance of lithium iron phosphate and improving the low-temperature performance of lithium iron phosphate.
2. Compared with Example 2, the lithium iron phosphate coated with carbon layer prepared in Example 13 has a carbon layer thickness of 7.2 nm, with a thicker carbon layer thickness, so that the resistance of charge transfer (R_{ct}), lithium ion diffusion rate D_{Li}, and the first discharge capacity per gram at a low temperature of −20° C. with a charge/discharge current density 2C in Example 13 were inferior to those in Example 2, but it was also possible to achieve the beneficial effects of the present disclosure. Compared with Example 6, the carbon layer thickness of the lithium iron phosphate coated with carbon layer prepared in Example 14 was 1.6 nm, with a thinner carbon layer thickness and less effective carbon coating than that of Example 6, so that the resistance of charge transfer (Rₑa), the diffusion rate of lithium ions, D_{Li}, and the first discharge capacity per gram at a low temperature of −20° C. with a charge/discharge current density 2C in Example 14 were inferior to those in Example 6, but it was also possible to achieve the beneficial effects of the present disclosure. The aforementioned results fully validated that the carbon layer thickness of 2-6 nm was shown to be excellent in coating lithium iron phosphate, reducing the polarization phenomenon during the migration process and playing a certain shielding role, thereby improving the stability of the battery, and the lithium-ion transport channel is short, which is conducive to further improving the rate performance of lithium-ion batteries.
3. Compared with Example 11, the lithium iron phosphate coated with carbon layer prepared in Example 15 had a larger D₅₀ of 1.67 m, so that the resistance of charge transfer (Rₑa), the diffusion rate of lithium ions, D_{Li}, and the first discharge capacity per gram at a low temperature of −20° C. with a charge/discharge current density 2C in Example 15 were inferior to those in Example 11, but it was also possible to achieve the beneficial effects of the present disclosure. Compared to Example 5, the lithium iron phosphate coated with carbon layer prepared in Example 16 had a smaller D₅₀ of 0.69 m, so that the resistance of charge transfer (R_{ct}), the diffusion rate of lithium ions, D_{Li}, and the first discharge capacity per gram at a low temperature of −20° C. with a charge/discharge current density 2C in Example 16 were inferior to those in Example 5, but it was also possible to achieve the beneficial effects of the present disclosure. The aforementioned results fully validated that when D₅₀ is in the range of 0.8-1.6 m, the lithium-ion migration channel is short, which shortens the diffusion distance of Li⁺ and further improves the rate performance of lithium-ion batteries, and also ensures a sufficiently sized particle diameter, so that the positive electrode active material is less likely to form soft agglomerates, which avoids blocking caused by the processing, and also further improves the rate performance of lithium-ion batteries.
4. The I_{D}/I_{G} values of the lithium iron phosphate coated with carbon layer prepared in the contrast examples 1-2 were below the range of 0.75-1.2 of the present disclosure, and the I_{D}/I_{G} values of the lithium iron phosphate coated with carbon layer prepared in the contrast examples 3-4 were above the range of 0.75-1.2 of the present disclosure. The resistance of charge transfer (Rₑa), the diffusion rate of lithium ions, D_{Li}, and the first discharge capacity per gram at a low temperature of −20° C. with a charge/discharge current density 2C in Contrast Examples 1-4 were significantly lower than those in Examples 1-16, and they fail to achieve the beneficial effect of the present disclosure for promoting the transfer of Li⁺ at the interface of the electrodes and the electrolyte and increasing the electrical conductivity of LiFePO₄ to improve the rate performance and improve the low-temperature performance of positive electrode material of lithium iron phosphate. The aforementioned results fully validated that when the I_{D}/I_{G} value of lithium iron phosphate coated with carbon layer in the present disclosure is 0.75-1.2, the desolvation rate of Li⁺ at the interface between the electrode and the electrolyte is improved, which enhances the desolvation ability, thereby increasing the electrical conductivity of lithium iron phosphate as well as the rate performance, and improves the low-temperature performance of lithium iron phosphate.

The I_{D}/I_{G} value of the lithium iron manganese phosphate coated with carbon layer prepared in Contrast Example 5 was 0.91, the carbon layer thickness was 3.6 nm, and the D₅₀ was 1.22 m, which were about the same as those of the lithium iron phosphate coated with carbon layer prepared in Example 1, which showed an I_{D}/I_{G} value of 0.90, a carbon layer thickness of 3.5 nm, and a D₅₀ of 1.20 m. However, the resistance of charge transfer (Rₑt), the diffusion rate of lithium ions, D_{Li}, and the first discharge capacity per gram at a low temperature of −20° C. with a charge/discharge current density 2C in Contrast Example 5 was significantly lower than those in Example 1 and were the worst among all the Examples and the Contrast Examples. The above results fully validated that if the present disclosure aims to improve the Li⁺ transfer rate at the interface between the electrode and the electrolyte, to improve the electrical conductivity of the lithium iron phosphate, and to improve the rate performance and improve the low-temperature performance of the lithium iron phosphate, the lithium iron phosphate material coated with carbon layer should be satisfied, and the I_{D}/I_{G} of the material should be 0.75-1.2 in order to achieve the beneficial effects of the present disclosure.

1. A positive electrode active material, comprising lithium iron phosphate coated with a carbon layer, and an I_{D}/I_{G} value of the positive electrode active material is 0.75-1.2, wherein a peak intensity at a wave number of 1360 cm⁻¹ is considered as I_{D}, and a peak intensity at a wave number of 1580 cm⁻¹ is considered as I_{G} in a Raman spectrum of the positive electrode active material.

2. The positive electrode active material according to claim 1, wherein the I_{D}/I_{G} value of the positive electrode active material is 0.8-1.0.

3. The positive electrode active material according to claim 1, wherein a thickness of the carbon layer is 2-6 nm.

4. The positive electrode active material according to claim 1, wherein D₅₀ of the positive electrode active material is 0.8-1.6 m.

5. The positive electrode active material according to claim 1, wherein a method of preparing the positive electrode active material comprises following steps: ball-milling a mixture of a FePO₄ precursor, a lithium source, a carbon source, and a dispersant, and sintering to prepare the positive electrode active material.

6. The positive electrode active material according to claim 5, wherein the FePO₄ precursor comprises at least one of FePO₄ and FePO₄ coated with a carbon source.

7. The positive electrode active material according to claim 5, wherein the carbon source comprises at least one of glucose and polyethylene glycol.

8. The positive electrode active material according to claim 7, wherein the carbon source comprises the glucose and the polyethylene glycol, wherein a mass ratio of the glucose to the polyethylene glycol is (0.6-1.2):1.

9. The positive electrode active material according to claim 5, wherein a temperature of the sintering is 680-720° C.

10. A lithium-ion battery, comprising a positive electrode active material, wherein the positive electrode active material comprises lithium iron phosphate coated with a carbon layer, an I_{D}/I_{G} value of the positive electrode active material is 0.75-1.2, a peak intensity at a wave number of 1360 cm⁻¹ is considered as I_{D}, and a peak intensity at a wave number of 1580 cm⁻¹ is considered as I_{G} in a Raman spectrum of the positive electrode active material.

11. The lithium-ion battery according to claim 10, wherein the I_{D}/I_{G} value of the positive electrode active material is 0.8-1.0.

12. The lithium-ion battery according to claim 10, wherein a thickness of the carbon layer is 2-6 nm.

13. The lithium-ion battery according to claim 10, wherein D₅₀ of the positive electrode active material is 0.8-1.6 m.

14. The lithium-ion battery according to claim 10, wherein a method of preparing the positive electrode active material comprises following steps: ball-milling a mixture of a FePO₄ precursor, a lithium source, a carbon source, and a dispersant, and sintering to prepare the positive electrode active material.

15. The lithium-ion battery according to claim 14, wherein the FePO₄ precursor comprises at least one of FePO₄ and FePO₄ coated with a carbon source.

16. The lithium-ion battery according to claim 14, wherein the carbon source comprises at least one of glucose and polyethylene glycol.

17. The lithium-ion battery according to claim 16, wherein the carbon source comprises the glucose and the polyethylene glycol, wherein a mass ratio of the glucose to the polyethylene glycol is (0.6-1.2):1.

18. The lithium-ion battery according to claim 14, wherein a temperature of the sintering is 680-720° C.
